(19) United States
(12) Patent Application Publication
(10) Pub. No.: US 2006/0080717 A1
(43) Pub. Date: Apr. 13, 2006

(54) Method and apparatus for providing credits through digital television interactive applications

(76) Inventors: Alon Barzilay, Tel Aviv (IL); Yuval Hamuz-Cohen, Tel Aviv (IL)

Correspondence Address: Mark M Friedman;Bill Polkinghorn, 9003 Florin Way, Upper Marlboro, MD, 20772, US

(21) Appl. No.: 10/536,254

(22) PCT Filed: Oct. 23, 2003
(86) PCT No.: PCT/IL03/00864

§ 371 Date: May 25, 2005

(30) Foreign Application Priority Data
Dec. 3, 2002 (IL) 153244

(51) Int. Cl. H04N 7/173; H04N 7/16

(52) U.S. Cl. 725/100; 725/135; 725/131

(57) ABSTRACT

Within a digital television environment comprising an operator (34), a distribution network (58), at least one set-top box (32), the set-top box (32) is communicatively associated with at least one viewing device (50), an apparatus and method for using interactive applications within a digital television environment, the apparatus and method assisting in implementing credit-based marketing programs such as the retention of viewers, the apparatus and method comprising an interactive digital application located and executed within the at least one set-top box (32), an application interface (92) through which a call is executed, and a set-top box software module (59) for processing viewer actions associated with a manipulation of credits either locally or through sending and receiving of messages.

### BACKGROUND OF THE INVENTION

1. Field of the Invention

The present invention relates to a method and apparatus for providing credits through digital television interactive applications along with local or centralized accounting of viewer's credits, in general and to a method and apparatus for implementing marketing redemption methods and programs, in particular.

2. Background of the Invention

Promotion and marketing by using television broadcasting is long known in the art nearly as long as the television broadcasting itself. Recent advances in digital television delivery technology enable delivery of television broadcast as well as software application to a viewing terminal also known as STB—set top box. This new technology is often referred to as interactive digital television or interactive television. Interactive television enables the user to view a television (video and audio) feed combined with download and execution of software application by a terminal processor. The software is able to use STB resources and in particular present graphics and text in an overlay, audible sound effect, handle remote control actions and the like. In many cases the STB is able to send information back to the digital television operator's head end or to other aggregation center via dedicated return channel or via other means, such as a telephone line and the like. While the interactive television technology is available, only limited use is being made of this technology. Most interactive television operators would normally use this technology for providing an electronic programming guide to the viewer. In some instances rudimentary services such as weather forecast, voting, sport statistics and simple games are also offered.

Marketing programs, such as incentive and reward plans have traditionally been used to provide strong incentive for buyers to continue shopping from the same source. A successful marketing program generates additional revenues and increases the Average Revenue Per User (ARPU), creates a differentiation to services or product offered by a service provider and reduce chum of customers by adding to their satisfaction through valuable credits and redemption offers. One example of a typical marketing program is a frequent flyer program. Travelers accumulate points for each mile flown. Having reached a certain number of miles travelers may redeem the points for free services, such as free flight tickets or upgrades such as from tourist class to business class. Such programs have developed and are now used widely by credit card companies and in various commercial scenes. Lately, these programs have even begun to be used in other fields by mutual collaborations of complementing industries. One example is the extension of the frequent flyer programs to include incentives for staying with program-sponsored hotels. In this example, travelers earn extra miles for staying with hotels associated with the frequent flyer program. A number of methods have been developed to electronically manage such programs over computers and computer networks. One such method is disclosed in U.S. Pat. No. 5,937,391 issued to Ikeda et al ('391). '391 discloses a service system in an online shopping mall where points are redeemed by a points redeeming unit through the use of a points dedicated server. Another method is disclosed in U.S. Pat. No. 5,117,355 issued to McCarthy ('355). '355 disclose a centralized system of accumulating cash value for consumers based upon point-of-sale transactions. These and like programs have been successfully implemented in association with computers and especially personal computers linked to data communication networks, such as the Internet. Another method is disclosed in U.S. Pat. No. 6,057,872 issued to General Instruments Corporation ('872). '872 disclose digital coupons for pay television using conditional access technology to track viewer's pay television usage and offer redemption only in the form of pay television services offered by the conditional access. Due to the different design of interactive television systems the designs offered this far for marketing programs over computer networks or conditional access technologies cannot be implemented in an interactive television system. There is thus a need for a method and system for implementing credit-based marketing programs through interactive software applications in a digital or interactive television system. Such credit-based marketing program will increase ARPU from additional viewers purchasing of products and services bundled with redemption of Credits in the marketing program, create differentiation using unique Operator's Credits based marketing program addressed only to Operator's viewers and reduce chum through increased satisfaction of viewers if the Operator has done an adequate job and the interactive application content will be relevant to the television programming presented there.

Another known promotion and marketing is marketing programs, such as incentive and reward plans used to provide strong incentive for buyers to continue shopping and to increase their expenditure from the same source or merchant. Credit-Based Marketing Programs (CBMP) have become prevalent in many industries. Almost every hotel chain, airline and credit card company offers a “frequent customer” program. Customers have come to expect them and compare benefits and rewards of competing companies. A successful marketing program generates additional revenues and increases the Average Revenue Per User (ARPU), creates a differentiation of services or product offered by a service provider and reduces churn of customers by increasing their satisfaction through valuable credits and redemption offers.

Existing CBMP such as loyalty programs, use the notion of credits to increase ARPU and customer retention. Wide spread implementation, in all the industries where CBMP was launched, such as airlines and credit card companies, coupled with better educated customers who seek greater access to data for comparison-shopping has reduced the effectiveness of CBMP since customers have little or no access to the overall information regarding the remaining credit's balance and are less exposed to the value of the accumulated credits and the available redemption offerings.

CBMPs typically tend to lose their uniqueness and efficiency over time. This phenomena occurs when the market becomes saturated, since leading players in any industry cannot afford not to implement a CBMP after it has been introduced by a competitor. Moreover, due to the large number of CBMPs, it becomes difficult for the customer to handle and track the Credits Account and the various redemption offers available to his/her personal needs. Since mass media distribution is expensive, the offers are typically printed and posted through monthly or quarterly mailing of brochures and letters, or within billing information.

In some cases there is a need to transfer or convert accumulated credits from one CBMP to another (typically in affiliate programs involving different industries, such as hotels and airlines). Such a need is not supported even though the customer is the same person for more than one CBMP. There is no centralized account, or gateway, which enables customers to access their credits accounts, or to convert the various CBMP accumulated credits. Different CBMPs typically manage stand-alone and identified accounts of credits for each CBMP and for each customer within each CBMP. There is no single location where a customers can view, move/convert and/or redeem their credits in the various existing CBMPs. Rudimentary alliances of CBMPs from affiliate industries such as hotels and airlines, enable conversion of credits from one CBMP to another, through the use of human Customer Services or Interactive Voice Routers (IVRs).

There is therefore a need for a method and system for implementing multiple CBMPs through interactive software applications in a digital or interactive television system. Such a system will enable customers to access existing CBMP accounts, receive on-screen redemption offers and handle conversions or transfers of credits between CBMPs. It will also enable television viewers to continuously view their current balance in any of the CBMPs available to them.

### SUMMARY OF THE INVENTION

The present invention can be used within a digital television environment comprising an operator head end, a distribution network, at least one set-top box, the set-top box is communicatively associated with at least one viewing device,

One aspect of the present invention regards an apparatus for using interactive applications within a digital television environment, the apparatus assists in the implementing credit-based marketing programs such as used to retain viewers, the apparatus comprising an interactive application located and executed within the at least one set-top box, an application interface through which a call is executed; and a set-top box software module for processing the application interface call associated with a manipulation of credits through sending and receiving of messages. The apparatus further comprises a local accounting device for managing credits within the set-top box, a message construct device for constructing a message and a message interpreter device for interpreting a message and a return channel interface for establishing a connection to a marketing program server through a return channel. Upon a predetermined event the local accounting unit generates a call to the message construct device. The message can comprise account identification and a data message indicating credits are to be manipulated or referring to an Account Action. The operator head end comprises a viewer manager and an aggregator, the operator head end is connected to a marketing program server, the marketing program server comprises a storage device, an accounting management program and an interface for receiving and sending information. The marketing program server is provided with information by operator head end from aggregator and viewer manager. The information from aggregator and viewer manager is received by interface that provides said information to accounting management program that conveys the received information to storage device. The accounting management program comprises at least one marketing program server application and at least one marketing program database associated with the storage device to store information. The storage device stores data related to accounts, accounts actions, credits, rewards, coupons, or viewer actions performed within an interactive application. The accounting management program comprises information relating to manipulation of credits in at least one viewer account. The marketing program server interprets a message received from the viewer's set-top box and in response sends a message to said viewer's set-top box. The message can include an Account Action. The Account Action can be a remote control unit action or a predetermined action identification code associated with credit manipulation or Account Action. The apparatus can further comprise an external program viewer manager. The external program viewer manager can be located external to the operator head end.

A second aspect of the present invention, regards an apparatus for using interactive applications within a digital television environment, the apparatus assists in the implementing credit-based marketing programs, the apparatus comprising an interactive application located and executed within the at least one set-top box; an application interface through which a call is executed; and a set-top box software module for processing the application interface call associated with a manipulation of credits through sending and receiving of messages. The apparatus further comprising a local accounting device for managing credits within the set-top box. The interactive application provides continuous user interface to an account status. The apparatus further comprising a message construct device for constructing a message and a message interpreter device for interpreting a message, and a return channel interface for establishing a connection to a marketing program server through a return channel. The local accounting unit upon a predetermined event generates a call to a message construct device. The message comprises account identification and a data message indicating credits are to be manipulated or referring to an account action. The account action is a remote control unit action or a predetermined action identification code associated with credit manipulation or account action. The set-top box is connected to an first marketing program server, the marketing program server comprises a storage device, an accounting management program and an interface for receiving or sending information. The accounting management program comprises a marketing program server application and a marketing program database associated with the storage device to store information. The storage device stores data related to accounts performed within an interactive application. The data related to accounts comprise one of the following types of information: accounts actions, credits, rewards, coupons. The accounting management program manages the manipulation of credits associated with an at least one viewer's account. The first marketing program server interprets a message received from the viewer's set-top box and in response sends a message to said viewer's set-top box. The message includes an account action. The the account action is a remote control unit action or a predetermined action identification code associated with credit manipulation. The apparatus further comprising a computing or a wireless device linked to the televised marketing program server via a communications network. The first marketing program server can be located external to the operator head end. The first marketing server located external to the operator head end is connected with a marketing program server located at the operator head end. The first marketing program server interprets a message received from the second marketing program server and in response sends a message to said second marketing server. The message includes an account action. The account action is a remote control unit action or a predetermined action identification code associated with credit manipulation. The the account action comprises an account identification associated with the first or second marketing program server. The apparatus further comprising an identification adapter module to translate between account identification in the first marketing program server and the account identification of a viewer in the second marketing program server. The first marketing program server comprises a mirror account, similar to the account managed by the second marketing program server. The apparatus further comprising a software module for synchronizing the set-top box account with the first or second marketing program server.

A third aspect of the present invention regards a digital television environment comprising an operator head end, a distribution network, a set-top box, the set-top box is communicatively associated with a viewing device, a method for using interactive applications within a digital television environment, the method assists in implementing credit-based marketing programs, the method comprising the steps of executing an interactive application capable of tracking an event; and initiating a call to a set-top box software module for the manipulation of credit through an account action. The method further comprising the step of displaying a graphic overlay on the viewing device enabling the viewer to respond via a remote control. The method further comprising the steps of the set-top software module transmitting data to a local accounting unit. The method of further comprising the step of processing data transmitted to a local accounting unit and performing a reply to the interactive application. The method further comprising the step of conveying the reply to the interactive application. The step of initiating a call comprises sending a message to a message construct device. The step of initiating is performed in accordance with a predetermined event. The method wherein predetermined event is a viewer event or an interactive application event. The method further comprising the step of retrieving the account identification associated with the viewer. The method further comprising the step of constructing a message to be sent to a marketing program server, the message comprising account identification and an account action. The method further comprising the step of sending the constructed message to an marketing program server via a return channel via a distribution network. The method further comprising the step of verifying whether return channel is open. The method further comprising the step of sending the constructed message to the marketing program server if the return channel is open for accounting process. The method further comprising the step of establishing a return channel if the channel is not open. The method further comprising the steps of awaiting a reply from marketing program server. The method further comprising the step of passing the message received from the marketing program server from the return channel interface to the message interpreter. The method further comprising the step of de-constructing the reply and extracting the data and passing the de-constructed data to an interactive application. The method further comprising the step of the interactive application provides information showing the user's account status in response to a user request or a predetermined event. The method further comprising the step of synchronizing account information located within the set-top box with a marketing program server. The method further comprising the step of translating between customer identification in a first marketing program server and identification of a viewer in a second marketing program server. The method further comprising the step of manipulating account information stored on the set-top box via the interactive application. The method further comprising the step of communicating account information stored on the set-top box or on a marketing program server to a wireless or a computing device.

### BRIEF DESCRIPTION OF THE DRAWINGS

The present invention will be understood and appreciated more fully from the following detailed description taken in conjunction with the drawings in which:

FIG. 1 is a schematic illustration of a Digital TV system, known in the art;

FIG. 2 is a schematic illustration of one preferred embodiment of the present invention;

FIG. 3 is a schematic illustration of the marketing program server according to one preferred embodiment of the present invention;

FIG. 3A is a schematic illustration showing an external marketing program server according to one preferred embodiment of the present invention.

FIG. 3B shows a schematic illustration of a system of multiple marketing servers, in accordance with another embodiment of the present invention.

FIG. 4A is a block diagram showing the Set-top Box Software Module (SSM) and its functionality within a STB unit according to one preferred embodiment of the present invention;

FIG. 4B is a block diagram showing the SSM and its functionality within a STB unit according to a second preferred embodiment of the present invention;

FIG. 4C is a block diagram showing the SSM and its functionality within a STB unit according to a third preferred embodiment of the present invention;

FIG. 5 is a flowchart showing an example of SSM software functional flow according to one preferred embodiment of the present invention;

FIG. 6 presents examples of implementation of Application displayed on screen display according to one preferred embodiment of the present invention;

FIG. 7 presents examples of screen display of an interactive Application displayed, according to one preferred embodiment of the present invention.

FIG. 8 illustrates a computer terminal accessing a marketing program server through a computer network, in accordance with the present invention.

FIG. 9 illustrates a wireless terminal accessing a marketing program server through a wireless network, in accordance with the present invention.

### DETAILED DESCRIPTION OF THE INVENTION

### DEFINITIONS

For the purpose of this document the following terms shall have the meaning defined herein:

“Operator” is a service provider that provides digital television to viewer. The operator may broadcast said service by cables (CATV), satellite (DSB), terrestrial (DVB-T), Digital Subscriber Line (DSL) or another way of communication.

“STB” is a computerized device connected to a screen and enables viewer's interaction through a remote control that facilitates television viewing and interactive services. Some STBs are capable of using a return channel (e.g. Telephone, Cable, DSL etc.) to transfer information from a STB to Operator's center.

“Applications” are computer programs executed by STBs also referred to as interactive applications. Typical Applications are able to use STB's resources such as presenting text and graphics in an overlay on top of the video, receive selections from a remote control and more. To the viewer, the interactive content appears as graphical, text and informational images on the screen overlaying a video broadcast The overlaying can be displayed in any shape, color, size or position. Often these images are opaque and cover the video broadcast in part or they are transparent or semi-transparent. Specific reoccurring interactive content images include icons, banners, labels, menus images and pictures. Application might be non-visual and handle events such as time measuring, channel change, pay-TV purchases and the like within a STB to grant Credits.

“Electronic Program Guide” or “EPG” is an Application designed for STBs that enables channel surfing, program guides, pay-TV and Pay-Per-View, and can function as a parental rating control setup viewing preferences and other.

“Digital Television” or “DTV” is a technique for broadcasting a digital television picture, sound, and data. The technique is based on standards such as digital video broadcasting (DVB) and the like.

“Credit” is a predefined unit having a redemption value that enables viewers to receive additional services from an Operator. The “Credit” can be named as a particular kind of goods with properties such as different types (e.g. bronze, silver, gold), colors, conversion rate, creation time, expiration date, factor, value etc. A Credit can be redeemed to any combination of money, service, product, discount, coupon and more. Credits can be used for co branded programs that the operator has with other companies. The credits can also be used as the solo currency for the operator products.

The present invention provides a marketing program apparatus and method (MPA) using Applications in DTV or interactive television that applies hardware and software modules for providing credit-based marketing programs such as retention programs and loyalty of viewers implemented in a digital or interactive television system. According to the present invention the MPA is operated by either a local or remote base responding to Application messages typically originated from viewer's action made using the remote control unit. The MPA learning ability can affect the spectator's watching habits, match marketing program offering, increase the Average Revenue Per User (ARPU), create differentiation, and retain viewers by using Applications presenting information and marketing program offers to the viewer. Furthermore the MPA provides the ability of differentiation between viewers and characterizing their preferences by tracking their preferences by tracking the way viewers choose to redeem credits and their participation response within an Applications (e.g. questions and presentations of gambling games) supplied by the MPA. The MPA of the present invention does not require communicating user input and preference to a local or remote base, rather the MPA is preferably implemented within the set top box (STB) at the premises of the subscriber.

The MPA uses the notion of Credits for achieving its goals for affecting viewers watching habits of DTV. According to the present invention viewers can gain Credits by consuming products or services and for interactive response to presented questions and other presentations received from the STB. The MPA records the credits accumulated by a viewer and redeems the accumulated Credits to provide the viewer with rewards, coupons and additional products or services. Increased ARPU results from additional selling of products and services provided with Credits received by viewer of DTV participating in the marketing program. The MPA performs analysis of viewer's interaction with Applications to provide information such as Credit collection, Credit redemption, frequency of usage, and the like. Marketing program helps to understand the potential of the existing customer base, customer's preferences and their habits such as what products and services subscribers buy and the like.

According to the present invention both viewers and Operators benefit from the advantages of the present invention. The viewer will benefit by receiving Credits that can be redeemed for rewards, reduction prices for products and services, and the like. The Operator benefit as well by increasing the viewer expenditure on additional products and services through purchasing opportunities using redemption of Credits. MPA helps the Operator to retain the viewers tuned to the programs broadcasted and gain information about the viewers' habits, interests and preferences. MPA that is implementing entertaining Applications (such as quiz with prizes and the like) can further reduce chum and thus reduce acquisition costs and lower operating costs since a typical business loses about half its customers' base every five years. On average, the cost of acquiring a new customer is five to 10 times greater than the cost of retaining a current customer. It is a lot easier to retain a customer than acquiring a new customer. In addition, MPA helps the Operator to create differentiation of services, such as in programs that might be also provided by the Operator's competitors, by adding credit-based Applications on top of the viewed program.

One skilled in the art will appreciate that one of the benefits of the present invention is that viewers provide valuable Application usage information willingly in return for Credits. For example, when an Application presents a trivia question, customers that will participate and answer (correctly or not) will receive a pre-defined number of Credits. By analyzing the information of Credit-based marketing program usage by customers the Operator can understand the potential of the existing viewers base, viewer's preferences and their habits. Furthermore, knowing viewer's interests and habits allows creating more efficient marketing programs, typically being a large expenditure from the Operator's budget, to be created with reduced risk and provide a high probability for return of expenditure.

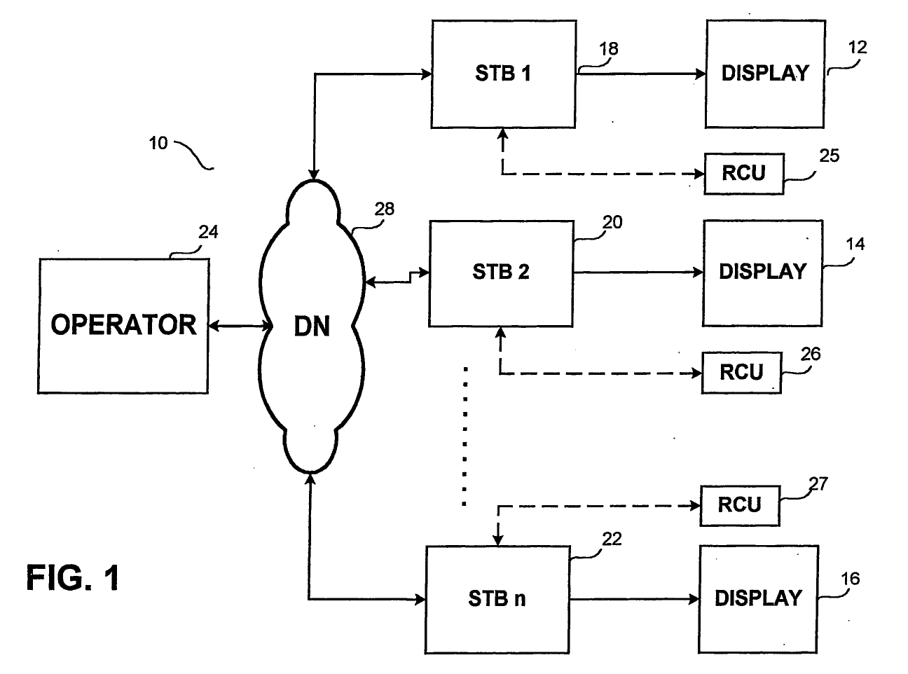

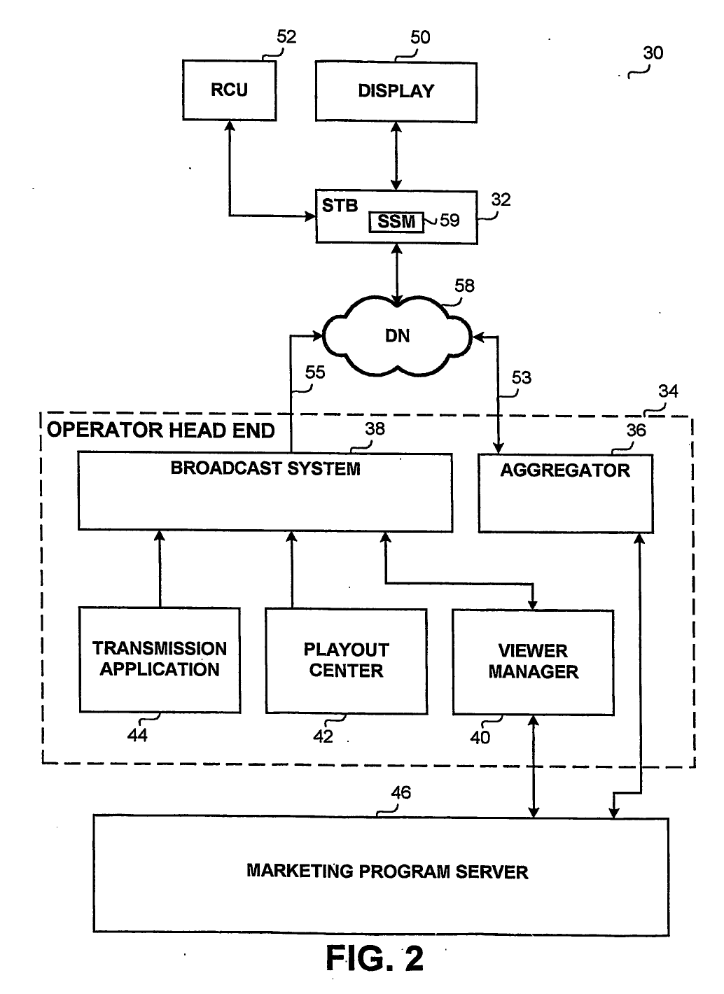

Reference is now made to FIG. 1 that presents prior art where an illustration of a typical DTV system 10 used for broadcasting television channels and Applications is shown. DTV system 10 is comprised of Operator 24, a Distribution Network 28 and a plurality of STBs 18, 20 and 22. STBs 18, 20 and 22 are each connected to display apparatus 12, 14 and 16 respectively such as television screens and communicate with remote control units (RCU) 25, 26 and 27 respectively such as wireless (infrared) remote control. The illustration shown is simplified, but a person skilled in the art will appreciate that numerous Operators and STBs may be located within one MPA. Distribution Network 28 is typically a cable TV broadcasting system (CATV), a satellite broadcasting system (DBS) or a terrestrial broadcasting system but can be also other communication networks such as DSL, the Internet, Cellular, LAN, WAN or other. DTV signals originating from Operator 24 are distributed through Distribution Network 28 to a plurality of STBs 18, 20, 22 which display the signals on screens 12,14,16 respectively. The STBs 18, 20, 22 can handle events originating from RCUs 25, 26, 27. In another embodiment, the interaction with the viewer may be accomplished using an enhanced RCU that is able to present the application text and graphics over a display device integrated within the RCU itself The STB downloads the application and communicate the application to the enhance RCU for display. The viewer can respond using keys in the enhanced RCU, which will communicate the actions to STB. The television viewing is normally done using the standard display device. In yet another embodiment, the interaction with the viewer may be accomplished using a personal computer designed to execute the Application and/or present the application text and graphics over the PC or PC connected display device. The STB downloads the application and communicate the application to the PC for display or execution. The viewer may respond using input devices connected to a PC such as keyboard, mouse and the like, which will communicate the actions to STB. A further understanding of the present invention will be in view of FIG. 2.

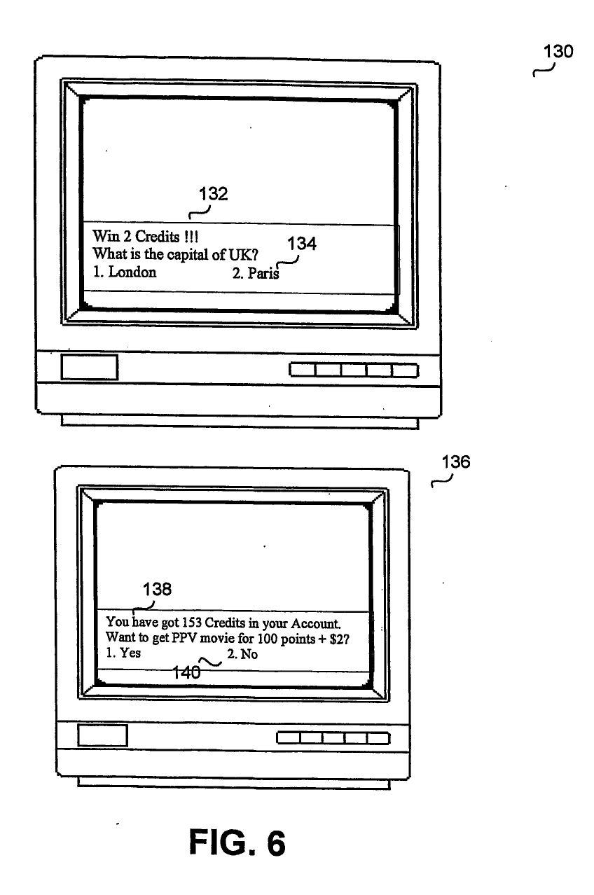

FIG. 2 provides a general overview of the system of the present invention according to one preferred embodiment of the present invention. MPA 30 includes an operator head end 34 that is connected to STB 32 using Distribution Network 58. STB 32 communicates with RCU 52 and sends television or audio/visual signals (e.g. UHF, Composite Video, RGB etc.) to screen 50 that can be a television or any other screen having the ability to present such signals. STB 32 uses screen 50 to present Application graphics and data on the screen mixed together with the television signals such as can be viewed in FIG. 6 described below. In another embodiment, the Application graphics and data can be communicated from a STB to a remote control device containing a screen.

The operator head end 34 is connected within the present embodiment of the MPA 30 to a marketing program server 46. The marketing program server 46 can be positioned either within the operator head end 34 or at a remote location linked with a standard communication means such as LAN, WAN, the Internet and the like. The marketing program server 46 collects and analyzes Application information received from STB 32 and manages accounting of Credit for each identified entity such as STB. The marketing program server 46 implements Credits redemption policies and can provide information through an interface to external systems or people that produces and develops Applications. According to the preferred embodiment of the present invention the connection between the viewer's STB 32 and the marketing program server 46 is performed through the operator head end 34. Operator head end 34 includes a broadcast system 38, an aggregator 36, a viewer manager 40, a playout center 42 and transmission application 44. The STB 32 can be a SkyB Digibox manufactured by Pace Digital Technology from Shipley West, Yorkshire, UK or like systems. The broadcast system 38 can be such a Television System 3000 manufactured by Tandberg Television from Southampton, UK or like systems. The aggregator 36 can be a public switched network (PSTN) modem bank such as Cisco 3600 manufactured by Cisco from San Jose, Calif., U.S.A. or Cable Interface Network Adapter such as DRC 7100 manufactured by Nextream from Cergy-Pontoise Cedex, France or like systems. The viewer manager 40 can be a “Wizard system” such as manufactured by Convergys from Cincinnati Ohio, USA or like systems. The playout center 42 can be a Playout Center and Automation manufactured by Sony from Basingstoke, UK or like systems. The transmission application 44 can be an OpenStreamer manufactured by OpenTV from Mountain View, Calif., U.S.A. or like systems.

The STB 32 is provided with a marketing program software module (SSM) 59. The SSM 59 is an application program interface, which can be installed within the STB 32 by the manufacturer according to one embodiment or downloaded by the operator head end 34 into the STB 32 according to another embodiment. The marketing program server 46 according to the present embodiment provides the viewer with Credits account management. According to the present invention Applications are put on transmission application 44, broadcasted through broadcast system 38 and Distribution Network 58 and downloaded and executed by the STBs. Though FIG. 2 presents only one STB 32 connected to Operator head end 34, according to the present embodiment a plurality of STBs can be connected to operator head end 34, all simultaneously operative to execute the SSM 59 of the present invention.

Broadcast System 38 transmits the data content relating to the application SSM 59 to STB 32 by means of delivery mechanism 55 and Distribution Network 58. The broadcasting transmission from broadcast system 38 to STB 32 can include but is not limited to broadband cable networks, satellite networks, terrestrial networks, high-speed telephone line services (such as DSL), wireless cable, wireless Digital Television system, and the like. STB 32 communicates with the return path aggregator 36 via the return channel 53 and Distribution Network 58. The communication between STB 32 and aggregator 36 is a two-way connection channel that can be performed via a cable, telephone, wireless or other telecommunications network. In other embodiments the delivery mechanism from broadcast system 38 and aggregator 36 can be united and performed by a single communications means. The Operator with the operator head end 34 controls the broadcasting content using play out center 42. Play out center 42 creates, monitors and controls the television programs and channels that are delivered to STB 32 and displayed on screen 50. The transmission performed is synchronized using a centralized clock system distributed within all operator head end 34 components (not shown). The transmission application 44 stores and manages Applications. Applications are typically created using STB 32 native programming language software development tools and uploaded to transmission application 44 that converts the application code and data to broadcasting format. According to the present embodiment the transmission application 44 is a periodic cyclic transmission mechanism that manages the process of inserting the Application code and data into the broadcast stream (such as MPEG-2 ISO 13818-6: DSM-CC). Television programs, ready for transmission, are transferred from play out center 42 to broadcast system 38. Broadcast system 38 compresses, multiplexes, modulates and broadcasts the data. Broadcast system 38 can include a conditional access to encrypt the data stream in order to enable pay television services such as VideoGuard provided by NDS, Staines Middlesex, UK. According to one embodiment the compression of the data can be accomplished according to the MPEG-2 standard (ISO 13818), although other like standards can be used as well. Transmitted signal to STB 32 according to one embodiment of the present invention includes the following data: clock services and channels information, multiple audio channels, multiple video channels, conditional access information, EPG data, subtitling, teletext control and management information and Application data. Once all the relevant data has been compressed, multiplexed and modulated by broadcast system 38, it is transmitted via delivery mechanism 55 and Distribution Network 58 to STB 32.

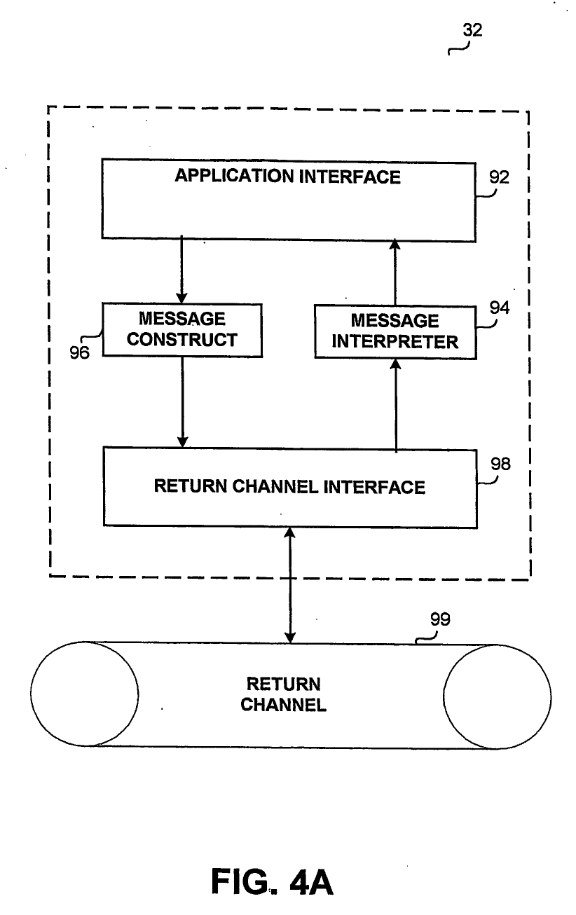

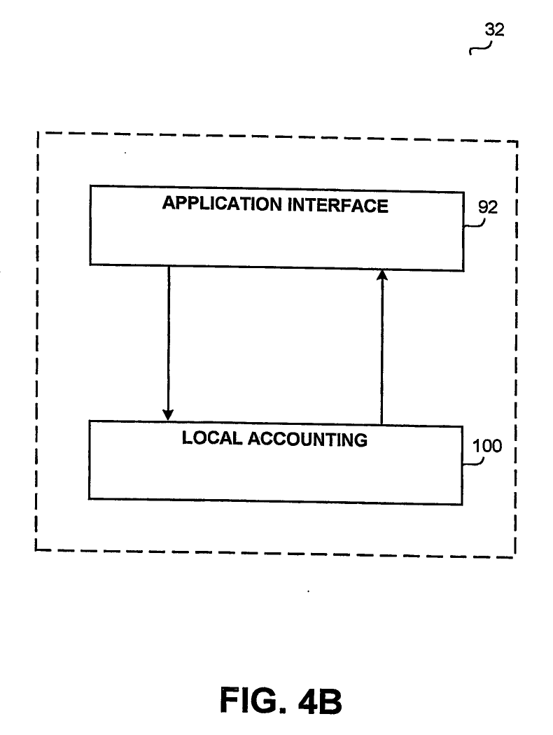

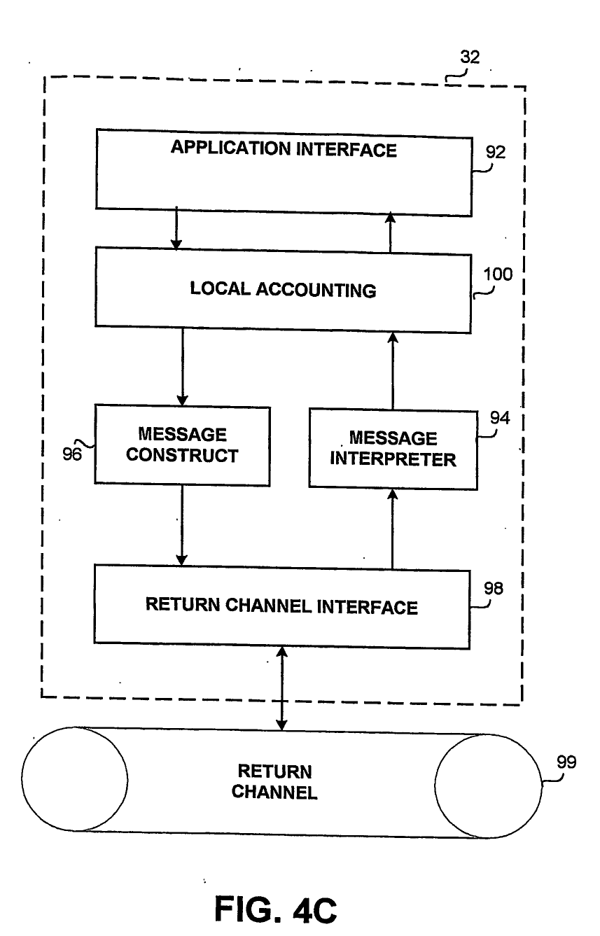

According to the present preferred embodiment STB 32 receives the transmitted signal and demodulates, demultiplexes, decrypts and decompresses said signal. STB 32 reconstructs the respective portions of the signal, which may comprise video, audio, Application code, and other broadcast data. According to the present embodiment of the invention, during the time the Application is broadcasted, STB 32 loads and executes the Application while the audio-video information, i.e., the normal television signal is conveyed to the television set. STB 32 executes Applications using hardware and software components that are compliant with the Applications code and data within the STB 32. For example, if the Application is written in HTML code, then STB 32 will include an HTML interpreter, such as a browser or the like. Typically, the viewer may control and manipulate the Application functionality, by for example responding to questions, by using RCU 52. RCU 52 can be a standard wireless remote control supplied with the STB 32. The RCU 52 can include a pointing device such as a mouse device, a wireless keyboard or a like device which enables making a selection according to presented options as described in view of FIG. 6 below. STB 32 receives commands from RCU 52 and passes the commands as events to be handled by the Application. For example, in one preferred embodiment of the present invention, the Application may request the viewer to participate in a poll whereby the viewer is requested to make a selection by either accepting or rejecting a request. The viewer may participate in the poll by depressing a designated key over the remote control. STB 32, upon receiving the viewer response, passes the key event to the Application that reacts to the returned command and displays to the viewer a feedback of his choices. STB 32 enables the Application to establish a two-way return channel connection 53 via Distribution Network 58 connecting to aggregator 36 that enables data transfer back and forth. For example, in a case where the Applications allocates a viewer Credits for his participation, information which may include the number of credits allocated and the user identification is sent from STB 32 and the Credits are added to the viewer's account in marketing program server 46. In case the viewer redeems Credits to purchase products or services, redemption information is transferred to viewer manager 40 for processing. According to the present embodiment, the communication between aggregator 36, viewer manager 40 and marketing program server 46 is accomplished by using standard communication means such as local area network (LAN), wide area network (WAN), Infiniband, ATM, fast Ethernet, and the like. In an alternative embodiment of the present invention, upon receiving the command provided by the viewer, the Application manages an Account of Credits locally in a memory within the STB 32. According to this embodiment the Credits are saved to the local non-volatile memory (such as Flash, E²PROM, disk drive and the like) of the STB 32 so that in case the STB 32 is turned off the Account information is not lost. An Application may access the Account information saved within STB 32 non-volatile memory to present the current status or to offer redemption options. The locally managed Account can be used when STB 32 is unable to establish a return channel or as store-and-forward mechanism that enables the Operator to operate the marketing program without having to handle a large number of return channel connections or request from the viewers. This presents a significant advance over the prior art as a large number of subscribers may wish to respond to a request made by the Application resulting in multitude of responses. In addition, the Operator does not have to maintain within the marketing program server 46 the list of Viewers and their respective Credits available for redemption. Other modes of operation and embodiments according to the present invention will be presented in view of FIGS. 4A, 4B and 4C below.

Viewer manager 40 controls and manages subscribers' rights together with billing account. Viewer manager 40 includes the subscriber's database, which comprises subscribers' related information such as name, address, viewing rights, pay per view orders, billing balance and other information. Viewer manager 40 instructs STB 32, through broadcast system 38, to block designated programs or channels. According to one embodiment the blocking system is an encryption and decryption system referred to as conditional access system. According to the present embodiment the marketing program is activated through the marketing program server 46 which manages accounting of Credits and acts as a management system through the Application containing software module that provides the Application the ability to access the Account and request Account Actions. The Application module complies with the STB's native programming language used such as HTML, C, Java, and others. In addition to viewer manager 40 an external marketing program manager (not shown) can interface with the MPA of the present invention. The external marketing program can manipulate credits relating to third parties. One example, is a an airline or a major credit card external marketing program for managing and manipulating credits relating to miles or points earned. The external marketing program may reside external and remotely to the marketing program server or external to the Operator's head end. The external marketing program may be located at a third party location.

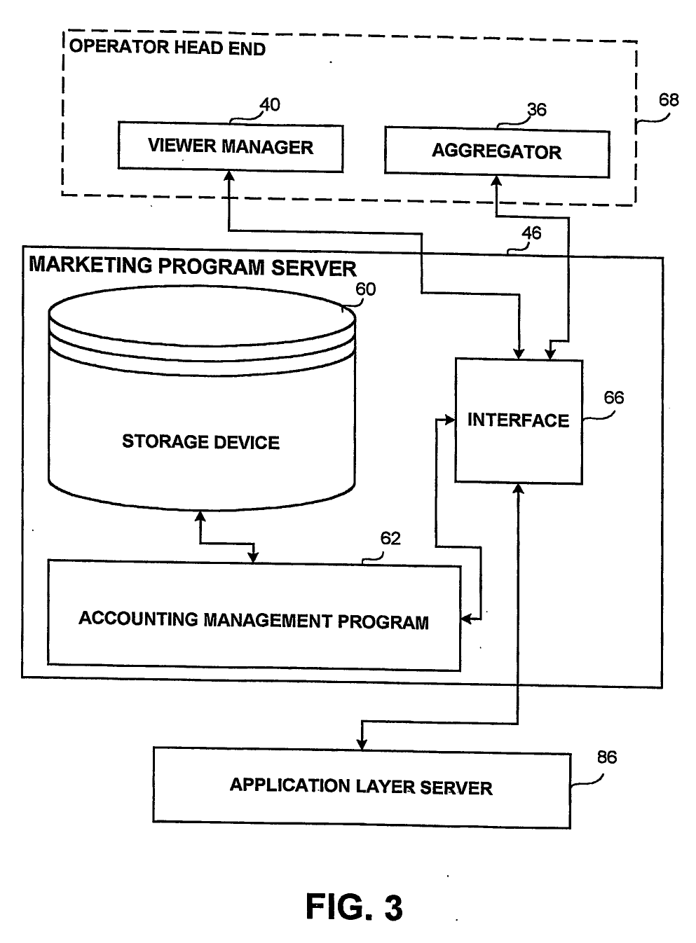

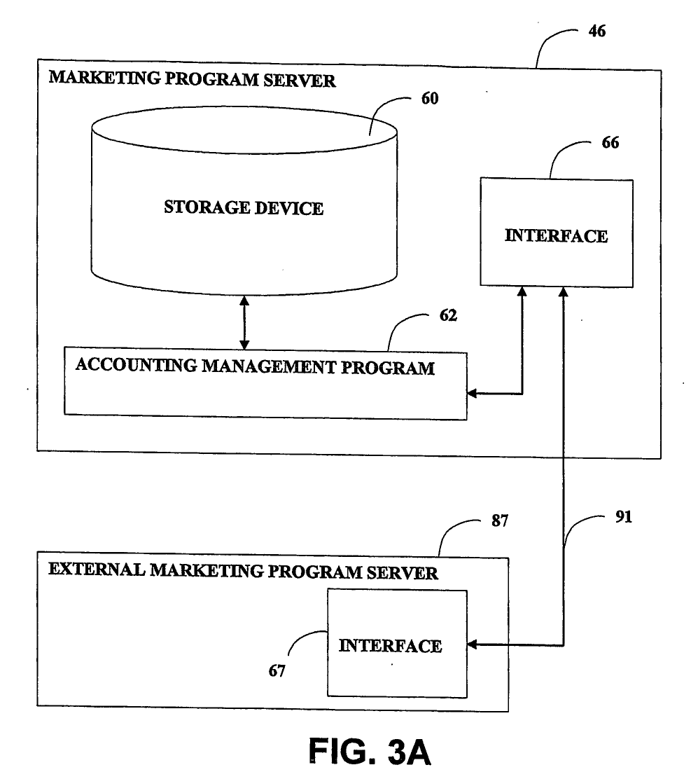

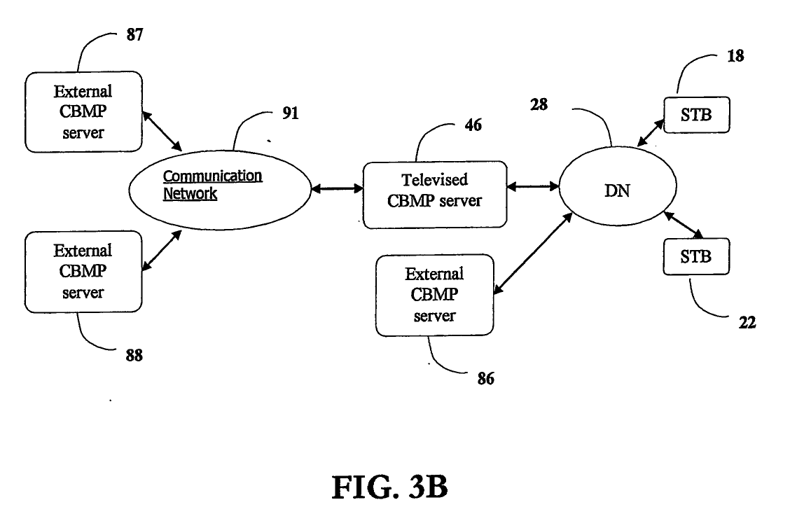

According to the preferred embodiment of the present invention the Operator may define a budget of Credits and their properties to be used in the televised marketing program. This budget is then distributed within Application containing marketing Program SSM 59 within STB 32, which may generate Account Actions executed on the Account by marketing program server 46. The function of marketing program server 46 will be understood and described in detail in association with FIG. 3 below.

FIG. 6 illustrates two examples according to the preferred embodiments of the present invention of application data displayed on screen 130 and screen 136. Screen display 130 presents a viewer with banner 132. Banner 132 provided by STB unit as shown in FIG. 1. Banner 132 is an Application presenting the viewer with an offer for receiving two credits by answering a question, “What is the capital of UK?”. Banner 132 offers two possible answers 134. The viewer is invited to gain two credits by cooperating with the system by indicating the correct answer with the RCU such as can be viewed in FIG. 1. As can be viewed in screen display 130 the banner is covering only part of the screen and enables the viewer to continue watching the program broadcasted prior to the appearance of banner 132 on screen display 130. The graphic overlay created by the Application can be displayed in any shape, color, size or position. Screen display 136 provides a viewer with an Application that is displayed to a viewer as banner 138. Banner 138 according to one embodiment is positioned on the lower part of screen display 136. Banner 138 contains a report of the accumulated Credits in the viewer's account and an offering to redeem some credits for a service. Thus, the offer is “Want to get PPV movie for 100 points+$2?”. The said redemption offer is followed with two answering possibilities “Yes” and “No”. The RCU operated by the viewer replies to the STB unit as also shown in FIG. 1. One skilled in the art can easily understand that the examples shown in FIG. 6 are merely examples and many other types of Application can be displayed on a screen by the STB. Application can contain multiple banners, other text phrases as well as audio, video and others that include direct messages to a viewer.

According to one embodiment the Application manipulates Credits using Account Actions that are passed to the marketing program server 46 or managed locally in the STB memory. According to another embodiment the Application pass the viewer's interaction events (e.g. what button was pressed in the RCU) to the marketing program server 46 which decides the Account Action or Credit manipulation to be made. According to the last embodiment the Operator has more flexibility in rewarding the viewer and can have an improved understanding of the viewers behavior.

FIG. 3 illustrates marketing program server 46 responsible for handling the marketing program implemented by the Operator. The marketing program server 46 may be implemented as a stand-alone computer connected to the Operator head end through standard communication means such as LAN, WAN, the Internet and the like or as a software module in an existing system within the Operator head end such as the viewer manager 40. Marketing program server 46 includes a storage device 60, an accounting management program 62, an interface 66 as well as a processor device (not shown), a communication device (not shown), an operating system (not shown), an input and output devices (not shown). The communication device provides the communication through a standard communication networks such as LAN, WAN, the Internet, and the like to the operator head end 68. The accounting management program 62 includes marketing program server applications and may also include a marketing program database that uses storage device 60 to store database information. As described in the embodiments shown in FIGS. 4A, 4B below, the Account Action information or viewer actions and decisions made in association with an Application are stored in the storage device 60. The actual Credits information is stored locally at the viewer's STB 32. In a third embodiment presented in FIG. 4C below, a combination of local accounting together with periodic updating of the marketing program server 46, which stores the information in the storage device 60 is illustrated. This third embodiment, that can also be referred to as “store-and-forward”, is used to accomplish handling of large number of STBs using the return channel connections by distributing the updates on a long time period such as once a month. The storage device 60 includes all data related to Accounts, Accounts Actions, Credits, rewards, coupons, viewer's actions within an Application and the like that can be provided by the present invention. The accounting management program 62 processes messages received from STB through the head end 68 (as can be viewed above in FIG. 2) from interface 66. The processing of accounting management program 62 includes, but is not limited to, registration of new credits in viewer's Account, subtraction of credits from Account, retrieving Account balance, storing and retrieving Account Actions and decisions taken by viewer within an Account. Said Account Actions and decision registered within storage device 60 can be redemption of credits, record of actual response to questions presented by an Application and the like displayed to the viewer on a screen such as shown in view of FIG. 6 above. In another embodiment, marketing program server analyzes the information stored in storage device 60, using statistical methods and the like to characterize a viewer and viewer's behavior, the information received within marketing program server 46 is provided by operator head end 68 from aggregator 36 and viewer manager 40 that were described in view of FIG. 2 above. In one embodiment, information from aggregator 36 and viewer manager 40 is received by interface 66 that provides said information to accounting management program 62 that conveys the received information to storage device 60. In another embodiment, the received information is further passed to application layer server 86. Similarly, in one embodiment interface 66 receives information from storage device 60 through accounting management program 62 and in another embodiment from application layer server 86. Application layer server 86 relates to the server is further described in U.S. Provisional Patent Application having Ser. No. 60/390,113 filed 21 Jun. 2002 and titled A System and Method for Developing and Televising an Interactive TV Applications which is incorporated herein by reference.

Reference is now made to FIG. 3A showing an external CBMP server 87 interfaces with the televised CBMP server 46 through interface 66. In the context of the present invention, the term CBMP server is used interchangeably with the term marketing program server. According to the present embodiment a third party or external CBMP is operated through an external CBMP server 87 which manages accounting of credits and acts as a management system used to manipulate credits, such as those used by an airline company to handle credits for each flight flown, or those used by credit card companies to manage Credits for each use of a credit-card for purchasing of goods and the like. Account Actions comprises the customer's identified Account in an external CBMP server 87 to customer's (i.e. viewer's) identified Account in the televised marketing program server 46 and vise versa Identification of an Account in each of the servers may typically be accomplished by using the STB serial number or the smart card number used by its conditional access system, by customer information such as for a non-limiting example, social security number, by credit card number and the like. An identification adapter module (not shown) is used to translate and synchronize between customer identification in an external CBMP and the identification of a viewer in the televised CBMP 46 and vise versa. Such an adapter module is typically implemented by using a mechanism that holds two unique identification pairs such as the smart card number and credit card number and the like, and allowing extracting one from the other. An identification adapter module can be implemented either within the CBMP 46 or within the external CBMP 87 or within a stand-alone system. External marketing program server 87 can further comprise a storage device (not shown), an accounting management program (not shown), an interface 67 as well as a processor device (not shown), a communication device (not shown), an operating system (not shown), an input and output devices (not shown).

According to the preferred embodiment, external CBMP server 87 communicates through standard communication channel 91 with the marketing program server 46. Standard communication channel includes, but is not limited to local area network (LAN), wide area network (WAN), Infiniband, ATM, fast Ethernet, and the like. A message is passed by interface 67 in the external CBMP server 87 through communication channel 91 to CBMP server 46 (and optionally visa versa) that includes parameters as indicated in Table 1, Table 2 and Table 3 below shown in association with FIG. 4A. In accordance to one preferred embodiment depicted in view of FIGS. 4A, 4B and 4C below a viewer can execute account actions, either locally and/or within the televised CBMP server, through the use of the RCU and an interactive application running in a STB.

FIG. 4A presents a block diagram representing the SSM and its functionality within a STB unit according to one preferred embodiment of the present invention. The Application initiates a function call to the SSM using the application interface 92 function declaration such as used in a C library. The application interface 92 function further initiates a function call to message construct device 96. According to one preferred embodiment of the present invention a message is created by message construct 96 that includes parameters as indicated in Table 1 below:

TABLE 1
Message structure

| integer | Char[] | char * |
|---|---|---|
| action_id | account_identification | Data |

The data includes an integer labeled action_id, a characters array labeled account_identification and characters string labeled data that construct a message referring to the action to be performed. The characters length can be fixed or null terminated or dynamic. If the character filed is dynamic an additional field stating the length of the character field can be used. The characters string labeled account_identification is typically STB serial number or smart card number used in a conditional access, and the like. The message constructed by the message construct device 96 is forwarded to return channel interface 98. The return channel interface 98 according to the present preferred embodiment illustrated in FIG. 4A forwards the message to return channel 99. Return channel interface 98 establishes a connection to marketing program server 46 through return channel 99 and conveys the message as can be viewed in FIG. 2 (general construction view of MPA) and FIG. 3 (a detailed view of marketing program server 46). According to the preferred embodiment viewed in FIG. 4A the message is received by marketing program server 46 and processed. Table 2 below demonstrates an exemplary list of action_id values within a message, constructed by message construct 96, defining Account Actions and the structure of the characters string labeled data.

TABLE 2
Messages Constructed and sent by STB

| action_id | Data (null terminated string) | Function |
|---|---|---|
| 0x0001 | None | Create account |
| 0x0002 | List of properties and values separated | Set account |
| | by semicolon (e.g. | properties |
| | “TYPE,2,PASSWORD,1234,GROUP,5”) | |
| 0x0003 | None | Get account |
| | | properties |
| 0x0004 | None | Delete account |
| 0x0005 | Number of credits (e.g. “2”) | Add credits |
| 0x0006 | Number of credits (e.g. “2”) | Subtract credits |
| 0x0007 | None | Request |
| | | balance |
| 0x0008 | None | Reset balance |
| 0x0009 | Account status (e.g. “ACTIVE”) | Set status |
| 0x000a | None | Get status |
| 0x000b | Starting date and time in MMM-DD-YYYY | Request history |
| | HH:MM (e.g. “Nov-11-2002 12:00”) | |
| 0x000c | Number of overdraft credits (e.g. “200”) | Set overdraft |
| | | limit |
| 0x000d | None | Get overdraft |
| | | limit |
| 0x000e | A list of account_identification separated by | Join accounts |
| | semicolon (e.g. using smart-card numbers for | |
| | identification “0100013252,0100236328”) | |

According to the one embodiment of the present invention the list of action_id in table 3 includes messages that are received by the STB as a reply from marketing program server 46.

TABLE 3
Messages Received and interpreted by STB

| action_id | Data (null terminated string) | Function |
|---|---|---|
| 0x1001 | “OK” or “BAD” | Create account |
| 0x1002 | “OK” or “BAD” | Set account |
| | | properties |
| 0x1003 | List of properties and values separated | Get account |
| | by semicolon (e.g. | properties |
| | “TYPE,2,PASSWORD,****,GROUP,5”) | |
| 0x1004 | “OK” or “BAD” | Delete account |
| 0x1005 | “OK” or “BAD” | Add credits |
| 0x1006 | “OK” or “BAD” | Subtract credits |
| 0x1007 | Number of credits in balance (e.g. “42”) | Request |
| | | balance |
| 0x1008 | “OK” or “BAD” | Reset balance |
| 0x1009 | “OK” or “BAD” | Set status |
| 0x100a | Account status (e.g. “ACTIVE”) | Get status |
| 0x100b | List of account actions starling the date | Request history |
| | and time requested in | |
| | MMM-DD-YYYY HH:MM action_id data | |
| | (e.g. “Nov-11-2002 12:00 | |
| | 0x0001<CR> Nov-11-2002 12:02 0x0004 | |
| | 3<CR>”) | |
| 0x100c | “OK” or “BAD” | Set overdraft |
| | | limit |
| 0x100d | Number of overdraft credits (e.g. “200”) | Get overdraft |
| | | limit |
| 0x100e | “OK” or “BAD” | Join accounts |

The exemplary protocol shown in tables 2 and 3 above includes messages containing an action_ids which are sent by the SSM and STB to the marketing program server 46. A message sent has a corresponding answer. So, for example, a message that includes action_id 0×0005 indicating that a number of credits have to be added to the account is construed and sent by the Application, SSM and STB. The message is received by marketing program server 46 and is replied with a message containing action_id 0×1005 indicating whether the action is approved or denied. The reply message originating from marketing program server 46 will be sent back to the Application through the return channel 99 and return channel interface 98 to the message interpreter 94. The message interpreter 94 de-constructs the received message in accordance to the example list of action_id described in Table 3 above, and conveys the characters string labeled data to the Application through the application interface 92 function.

Persons skilled in the art will readily appreciate the operation of the various messages from the tables shown above. One skilled in the art can easily understand that the examples presented above are by no means limiting and are presented merely to demonstrate one embodiment of the present invention. Additional variations and additions will easily be introduced to further assist in the communication between Application and marketing program server 46. The present invention contemplates such additions and modifications.

In another preferred embodiment, a message constructed by the SSM as described in FIG. 4A contains the viewer RCU actions without an Account Action but with additional information containing the Application identification. Application identification is typically a unique integer number within the Application assigned by the Operator head end to each Application loaded on the transmission application 44 as illustrated in FIG. 2. The marketing program server 46 holds list of Application and actions such as described in the following exemplary Table 4.

TABLE 4
Example list of Application and actions

| Application | | |
|---|---|---|
| identification | Viewer RCU actions | Account Action |
| 503 | Button “1” | No action |
| 503 | Button “2” | Add 10 Credits |
| 503 | Any other button | No action |
| 504 | Button “Green” | Subtract 2 Credits |
| 504 | Button “Blue” | Add 100 Credits |
| 504 | Any other button | No action |
| 505 | Any other button | Send reply message with |
| | | Credit Balance |

Upon receiving the message from SSM, the marketing program server 46, interpret the message, searches through the list of Application to identify the Application and determines the Account Action to be accomplished in the viewer's Account according to the viewer RCU action. One example of such a message will contain Application identification equal to 503 with viewer RCU action Button “2”. The marketing program server 46 will find the appropriate line in the list of Application and actions and will Add 10 Credits to the viewer's Account which is identified as described in exemplary Table 1 above.

FIG. 4B presents a block diagram representing the SSM and its functionality within a STB unit according to a second preferred embodiment of the present invention that operates the accounting in the STB 32 itself and does not require any communication to be performed with a marketing program server 46. According to the present embodiment the MPA does not include a marketing program server 46. The Application initiates a function call to the SSM using the application interface 92 function declaration such as used in a C library that one skilled in the art can easily understand. The STB 32 within the MPA of the present embodiment includes an application interface 92 function that has identical abilities as explained in view of FIG. 4A above. Nevertheless, the present embodiment does not include a return channel interface and a return channel in order to implement the present invention and does not include a message construct and message interpreter steps. The present embodiment includes a local accounting device 100 that performs similar function performed by the marketing program server 46 that was described above in view of FIG. 4A accomplished on one Account only. According to embodiment described in FIG. 4B of the present invention application interface 92 initiates a function call to local accounting 100. The local accounting unit 100 uses a memory device within the STB for storage of information such as changes made to Credit balance, viewer response to the Application made by the RCU, viewer parameter, and the like. The memory device can be any a readable and writable memory device, located locally within the STB or detached from the STB and located on a crad or in the RCU. Optionally, the accounting unit 100 further generates a reply data in the form of characters string, as described in Table 2 above, that is conveyed back to the Application through the application interface 92 function. The generation of a reply data is optional and will be preferably performed to maintain compatibility with the Application calls to the SSM. The present embodiment does not require a message transmission to be performed by protocol since the accounting of Credits or in accordance to another embodiment the viewer actions accounting is executed locally in the STB.

FIG. 4C presents a third embodiment of the present invention. The present embodiment includes a return channel interface 98 and a connection to a return channel 99 that provides the connection to the marketing program server 46 similar to the embodiment illustrated in FIG. 4k However, the present embodiment includes a local accounting unit 100 that enables the STB 32 to process and manage the accounting locally as described in view of the embodiment illustrated in FIG. 4B above. According to the present embodiment of the invention the MPA has the ability to manage the accounting locally within the local accounting unit 100 and periodically send the data regarding the viewer's account status, accumulated credits, credit redemption performed and the like to the marketing program server 46. In the present embodiment, local accounting unit 100 includes additional functionality initiating a function call to message construct 96 in predetermined conditions or events. The message construct 96 creates a message as illustrated in FIG. 4A and indicated in Table 1 and Table 2 above. The message is conveyed to the return channel interface 98 that transmits the message to marketing program server 46 through return channel 99. The events which may trigger the function call to message construct 96 may include a certain time of day, Credit balance exceeds a certain amount, the user has entered a specific code on the RCU, the marketing program server and a like. For example, the event may be triggered and performed at predetermined times or upon an action by the subscriber or upon a predetermined rule set by the Application including such as number of Credits, hours of use, Application launch and the like. Upon receiving the data from return channel 99 the marketing program server 46, as can be viewed in FIG. 3 above, update its records and can communicates with application layer server 86 as described in view of FIG. 3 above. The marketing program server 46 sends a reply message, as described in Table 3 above, which is conveyed through return channel 99 and return channel interface 98 to the message interpreter 94. The message interpreter 94 de-constructs the received message, in accordance to the example list of action_id described in Table 3 above, and conveys the characters string labeled data to the local accounting unit 100, which updates the local account information. The local accounting unit 100 further sends the characters string labeled data to the Application through the application interface 92 function.

Referring now to FIG. 3B where a system of multiple CBMP (marketing) servers are communicating in order to enable manipulation of credits through the use of interactive application executed by a STB. In a preferred embodiment, for STB 18 that communicates with the televised CBMP 46 through the Distribution Network (DN) 28 using return channel, Account Actions are generated and sent to an external CBMP with an optional execution of Account Actions within the televised CBMP 46. In this embodiment, Account Actions made with Credits managed by external CBMP server 87 are sent from the STB through the televised CBMP server 46 to the external CBMP 87. The external CBMP server 87 is connected to the televised CBMP server 46 through communication network 91 such as local area network (LAN), wide area network (WAN), Infiniband, ATM, fast Ethernet, and the like. STB 18 is connected to DN 28, which typically has access to a return channel network such as the telephony network, cable return channel or the Internet or intranet.

In another preferred embodiment, an interactive application (not shown) executed by the STB 18 issues Account Actions that are sent directly to the external CBMP server 86. One skilled in the art can easily understand that the connection between the STB and the external CBMP server 86 can be accomplished using through the use of a PSTN modem and the telephony network or a cable modem and the cable network that enables the transfer of two-way data between the STB and the external CBMP server 86 such as typically used by a personal computer accessing the Internet.

The communication protocol defined between the STB and the televised CBMP 46 such as described in Table 1, Table 2 and Table 3 shown above in association with FIGS. 4A, 4B, 4C can adequately be used between the televised CBMP 46 and the external CBMP 87 or between STB 18 and external CBMP 86. For example, if an Account Action to retrieve the current Credit balance from an external CBMP 87 is initiated by the STB 18 for the first time, in the preferred embodiment it is sent through the televised CBMP 46 which receives the message, interpret it and further generates a new message sent to the external CBMP 87. In another embodiment the message is sent from the STB 18 directly to the external CBMP 86 through the return channel. The resulting message generated by the external CBMP 87 is sent back, either through the televised CBMP 46 to the STB 18 or directly to the STB 18 from external CBMP server 86 which interprets the result, presents it to the viewer in response to his request and optionally records it in the local account for future use. In the preferred embodiment, the televised CBMP 46 manages a “mirror” account, similar to the account managed by the external CBMP 87. The term mirror refers to a copy of the account managed by the external CBMP 87. The local account is updated each time the viewer logs into the external CBMP 87 or at predetermined intervals.

Specific predetermined events, such as purchase or logging into a specific service and the like, creates a trigger to generate an Account Action sent from the external CBMP 87 to the televised CBMP server 46 through a standard communication path or channel such as local area network (LAN), wide area network (WAN), Infiniband, ATM, fast Ethernet, and the like. The information updates the “mirror” account within the televised CBMP server 46. The next time the STB 18 initiates a connection to the televised CBMP server 46 or to the external CBMP server 87, a synchronization software module (not shown) executes Account Actions in order to update the local credits account with the televised CBMP server's 46 credits account or the external CBMP server's 87 credit account. The Local accounting further enables the account information to continuously display the current balance from the local account information, in any of the CBMPs (both televised and external ones).

In one preferred embodiment, an interactive Application for the conversion of Credits from one external CBMP server 87 to another external CBMP server 88 is supplied. The application holds a pre-defined rate conversion ratio and enables viewers using the RCU to execute Account Actions to redeem credits from one Account in one external CBMP server 87 and to add the redeemed Credits converted by the conversion ratio to another Account in another external CBMP server 88.

The method further includes a mechanism to either act as a televised gateway to existing credit-based marketing programs or as a rate converter to a newly defined credit that can be used on the television. For example, one credit of an airline company (i.e. an Air mile) will be worth five television credits, and ten credits of a credit card will be worth one television credit. A third mechanism combines the usage of a gateway as well as a converter to a local/server-based account of televised credits. In one preferred embodiment, the interactive application is used as a single-point for viewing all the CBMP accounts on the TV screen.

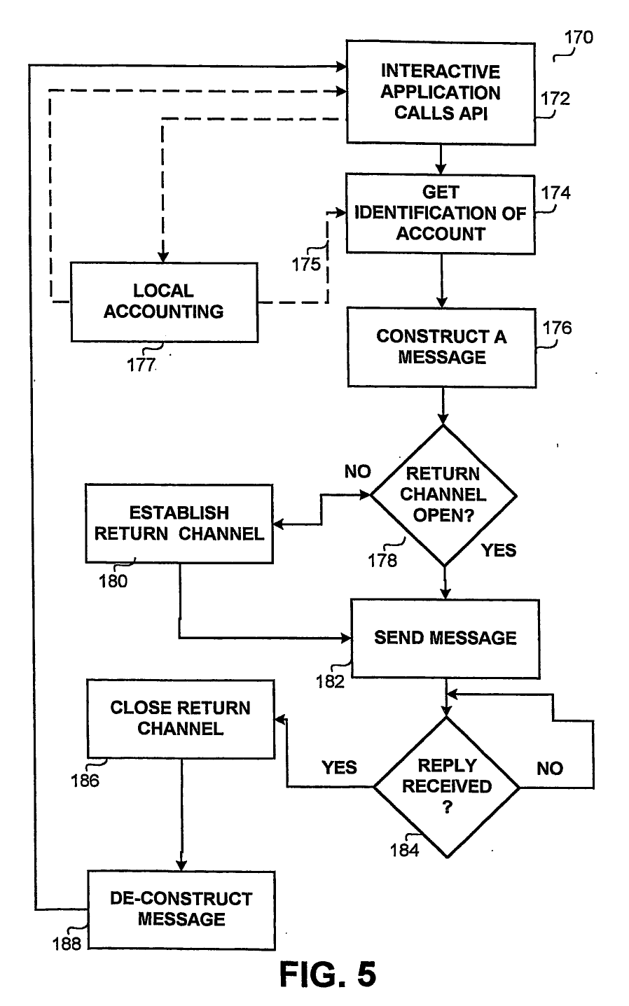

FIG. 5 provides a flowchart showing the operation of the SSM according to one preferred embodiment of the present invention. According to the one embodiment of the present invention, illustrated in FIG. 4A above, an Application presents a graphic banner displayed on the screen of the viewer enabling the viewer to response via RCU. An example of such graphic banner is illustrated in association with FIG. 6 above. In step 172 upon response of viewer to notations shown by the banner (such as questions or invitation of redemption activates), the interactive application initiates a function call to the SSM (application program interface) 92 of FIGS. 4A, 4B, 4C. The response from viewer may be realized through the viewer's use of the RCU 25, 26, 27 of FIG. 1. Next, according to one preferred embodiment such as illustrated in FIG. 4B, in step 177 the SSM transmits data (the result of the function call) to the local accounting unit 100 of FIG. 4B. The local accounting processes the data as described in association with FIG. 4B above and replies to the interactive application that transmits the reply data to the Application that may display it on the viewer's screen. According to the embodiment shown in FIG. 4B only steps 172 and 177 are performed.

In another alternative embodiment such as described in association with FIG. 4C after step 177 was performed and in response to certain events, including predetermined or viewer or server driven events the data received by the local accounting unit 100 of FIG. 4C is passed on in step 175 to the message construct device 96. Next in step 174, in the alternative embodiments, such as the ones described in association with FIGS. 4A and 4C the SSM retrieves identification of account from STB serial number or smart card number used in a conditional access and the like. Next, in step 176 a message is constructed as described in detail above in association with FIGS. 4A, 4C. Next, in step 178 the message constructed is sent to the-marketing program server 46 of FIG. 1 via the return channel 99 of FIGS. 4A, 4C via the Distribution Network 28 of FIG. 1. At step 178 the SSM verifies whether return channel is open. If the return channel is open then in step 182 the message is sent to the marketing program server 46 of FIG. 2. The message is sent to marketing program server 46 for accounting process as described above in association with FIG. 3. If the channel is not open then in step 180 an attempt is made to establish of return channel, either immediately or later, and the flow proceeds again to step 178 to verify that the channel is open. Next, in step 184 and after said message is sent to marketing program server 64 the SSM 59 of FIG. 2 awaits a reply from marketing program server 46. In step 186 when a reply is received from marketing program server the return channel is closed. Next, in step 188 the message received from the marketing program server 46 is passed by the return channel interface 98 of FIG. 4A, 4C to the message interpreter 94 of FIG. 4A, 4C and is de-constructed and the reply data is extracted and passed to the interactive application interface for passage to the SSM 92 of FIG. 4A, 4C.

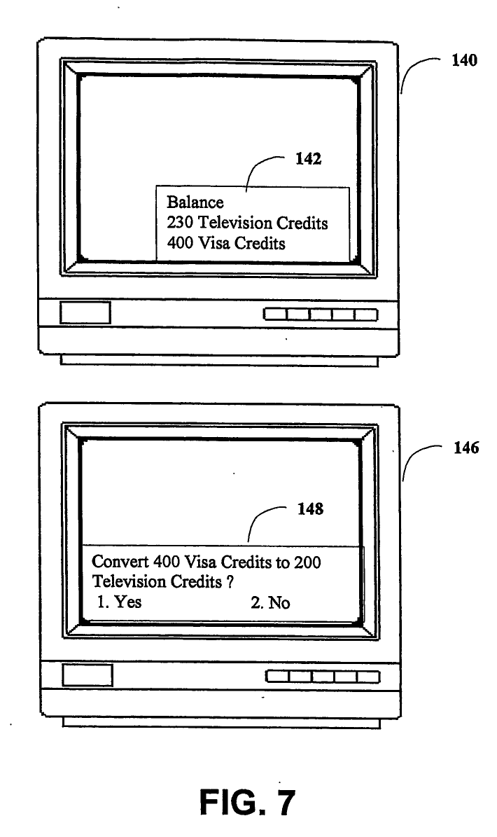

Reference is now made to FIG. 7 where an example of screen display of an interactive Application is displayed according to one preferred embodiment of the present invention. FIG. 7 illustrates two examples according to the preferred embodiments of the present invention of application data displayed on screen 140 and screen 146. Screen display 140 presents a viewer with banner 142. STB unit as shown in FIG. 1 provides banner 142. Banner 142 is an Application presenting the viewer with the current balance of credits from two different CBMP accounts. As noted above the current balance can be retrieved directly by the STB from a an external marketing server, or via a televised marketing server and have such information stored there within. The viewer is able to hide or display the banner using button selections on the RCU as can be viewed in FIG. 1. As can be viewed in screen display 140 the banner covers only part of the screen and enables the viewer to continue watching the program broadcasted prior to the appearance of banner 142 on screen display 140. The graphic overlay created by the Application can be displayed in any shape, color, size or position.

Screen display 146 provides viewers with an Application that is displayed as banner 148. Banner 148, according to one embodiment, is positioned at the lower part of screen display 146. Banner 148 presents an offer to convert accumulated Credits from one CBMP to another. Thus, the offer is “Convert 400 Visa Credits to 200 Television Credits?”. The said conversion offer is followed by two response options: “Yes” and “No”. The RCU operated by the viewer replies to the STB unit as also shown in FIG. 1. One skilled in the art can easily understand that the examples shown in FIG. 7 are merely examples and many other types of Application can be displayed on a screen by the STB. Applications can contain multiple banners, other text phrases as well as audio, video and others that include direct messages to a viewer.

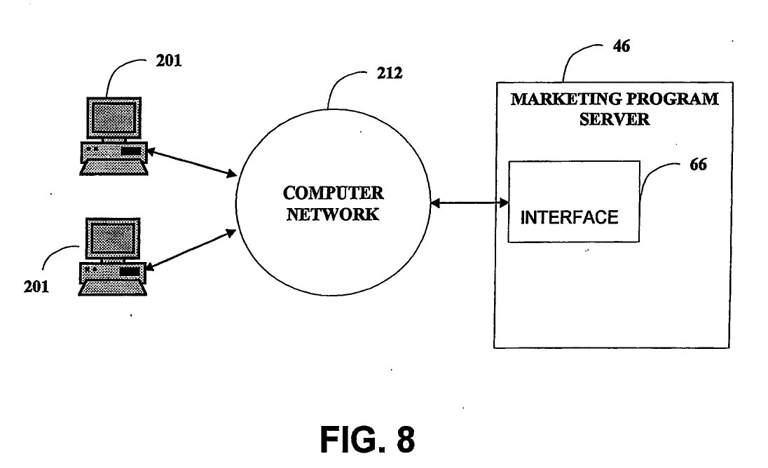

FIG. 8 illustrates computer terminal 201 accessing marketing program server 46 through computer network 212. In accordance with the present invention computer terminals 201 and other like device can access directly marketing program server 46 via computer network 212 such as the Internet or an intranet. Computer terminal 201 is a personal computer typically located remotely that includes a storage device (not shown), a memory device (not shown) as well as a processor device (not shown), a communication device (not shown), an operating system (not shown), an input and output devices (not shown) and an internet client application such as internet explorer manufactured by Microsoft Corporation from Redmond, Wash. USA or like application. The illustration shown is simplified, but a person skilled in the art will appreciate that numerous computer terminal 201 may be located within one computer network 212. Such can include personal data assistants, and wireless devices linked to a data communications network such as the Internet or intranet. In one preferred embodiment, Account Actions are made in the marketing program server 46 by a computer terminal 201. A message is created by internet client applications using for example HTML, Java Script and the like languages and passed through computer network 212 to marketing program server 46 and optionally visa versa that includes parameters as indicated in Table 1, Table 2 and Table 3 shown in association with FIGS. 4A, 4B, 4C. Identification of an Account is typically accomplished by using the STB serial number or smart card number used in a conditional access, customer information (e.g. social security number), credit card number and the like.

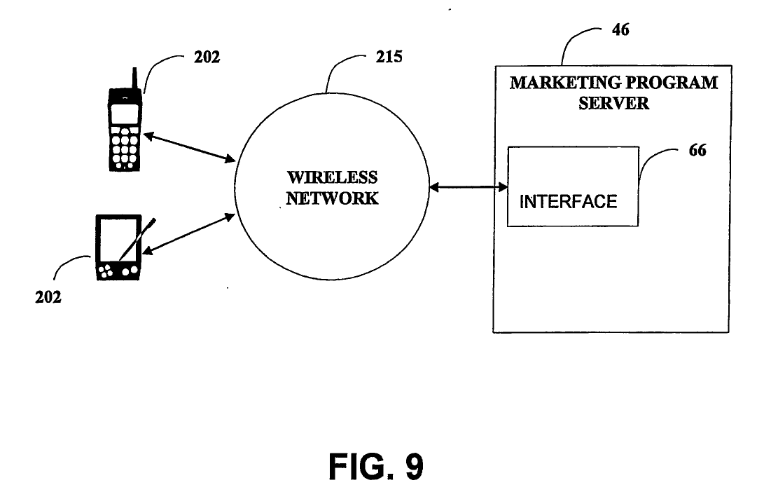

FIG. 9 illustrates wireless terminal 202 accessing marketing program server 46 through wireless network 215. Wireless network 212 can be a communication network such as cellular, radio frequency (RF), infrared and the like. A wireless terminal 202 is a mobile phone or a personal digital assistant (PDA) typically located remotely that includes a memory device (not shown) as well as a processor device (not shown), a wireless communication device (not shown), an operating system (not shown), an input and output devices (not shown) and an application. The illustration shown is simplified, but a person skilled in the art will appreciate that numerous wireless terminal 202 may be located within one wireless network 215 In one preferred embodiment Account Actions are made in the marketing program server 46 by a wireless terminal 202. A message is created by an application such as WAP, Java or J2ME and the like and passed through wireless network 215 to the marketing program server 46 and optionally visa versa that includes parameters as indicated in Table 1, Table 2 and Table 3 shown in association with FIGS. 4A, 4B, 4C. Identification of an Account is typically accomplished by using the STB serial number or smart card number used in a conditional access, customer information (e.g. social security number), credit card number and the like.

One skilled in the art will appreciate that one of the benefits of the present invention is that users such as viewers or customers can execute Account Actions in their Account at any time and through any devices connected to communication network or wireless network. This provides continuous access to the Account that enables customers to collect or redeem Credits any time, anywhere. For example, when an Application presents a trivia question on a television set through a STB, customers that will participate and answer (correctly or not), will receive a pre-defined number of Credits. These Credits (e.g. balance) can be viewed through a wireless terminal such as cellular phone and moreover, enable the user to redeem the Credits to services or goods as they like.

The person skilled in the art will appreciate that what has been shown is not limited to the description above. Those skilled in the art to which this invention pertains will appreciate many modifications and other embodiments of the invention It will be apparent that the present invention is not limited to the specific embodiments disclosed and those modifications and other embodiments are intended to be included within the scope of the invention. Although specific terms are employed herein, they are used in a generic and descriptive sense only and not for purposes of limitation.

1. Within a digital television environment comprising an at least one operator head end, an at least one distribution network, an at least one set-top box, the at least one set-top box is communicatively associated with an at least one viewing device, an apparatus for using interactive applications within a digital television environment, the apparatus assists in the implementing credit-based marketing programs, the apparatus comprising:
an interactive application located and executed within the at least one set-top box
an application interface through which a call is executed; and
a set-top box software module for processing the application interface call associated with a manipulation of credits through sending and receiving of messages.

2. The apparatus of claim 1 further comprising a local accounting device for managing credits within the set-top box.

3. The apparatus of claim 2 wherein the interactive application provides continuous user interface to an account status.

4. The apparatus of claim 1 further comprising a message construct device for constructing a message and a message interpreter device for interpreting a message.

5. The apparatus of claim 1 further comprising a return channel interface for establishing a connection to a marketing program server through a return channel.

6. The apparatus of claim 2 wherein the local accounting unit upon a predetermined event generates a call to a message construct device.

7. The apparatus of claim 1 wherein the message comprises an account identification and a data message indicating credits are to be manipulated or referring to an account action.

8. The apparatus of claim 7 wherein the account action is a remote control unit action or a predetermined action identification code associated with credit manipulation or account action.

9. The apparatus of claim 1 wherein the at least one set-top box is connected to an at least one first marketing program server, the at least one marketing program server comprises a storage device, an accounting management program and an interface for receiving or sending information.

10. The apparatus of claim 9 wherein the accounting management program comprises at least one marketing program server application and at least one marketing program database associated with the storage device to store information.

11. The apparatus of claim 9 wherein the storage device stores data related to accounts performed within an interactive application.

12. The apparatus of claim 11 wherein the data related to accounts comprise one of the following types of information: accounts actions, credits, rewards, coupons.

13. The apparatus of claim 9 wherein the accounting management program manages the manipulation of credits associated with an at least one viewer's account.

14. The apparatus of claim 9 wherein the at least one first marketing program server interprets a message received from the viewer's set-top box and in response sends a message to said viewer's set-top box.

15. The apparatus of claim 14 wherein the message includes an account action.

16. The apparatus of claim 15 wherein the account action is a remote control unit action or a predetermined action identification code associated with credit manipulation.

17. The apparatus of claim 9 further comprising a computing or a wireless device linked to the televised marketing program server via a communications network.

18. The apparatus of claim 9 wherein the at least one first marketing program server is located external to the at least one operator head end.

19. The apparatus of claim 18 wherein the at least one first marketing server located external to the at least one operator head end is connected with an at least one marketing program server located at the at least one operator head end.

20. The apparatus of claim 19 wherein the at least one first marketing program server interprets a message received from the at least one second marketing program server and in response sends a message to said at least one second marketing server.

21. The apparatus of claim 20 wherein the message includes an account action.

22. The apparatus of claim 21 wherein the account action is a remote control unit action or a predetermined action identification code associated with credit manipulation.

23. The apparatus of claim 22 wherein the account action comprises an at least one account identification associated with the at least one first or second marketing program server.

24. The apparatus of claim 19 further comprising an identification adapter module to translate between account identification in the at least one first marketing program server and the account identification of a viewer in the second marketing program server.

25. The apparatus of claim 19 wherein the first marketing program server comprises a mirror account, similar to the account managed by the at least one second marketing program server.

26. The apparatus of claim 20 further comprising a software module for synchronizing the at least one set-top box account with the at least one first or second marketing program server.

27. Within a digital television environment comprising an at least one operator head end, an at least one distribution network an at least one set-top box, the at least one set-top box is communicatively associated with an at least one viewing device, a method for using interactive applications within a digital television environment, the method assists in implementing credit-based marketing programs, the method comprising the steps of:
executing an interactive application capable of tracking at least one event; and
initiating a call to a set-top box software module for the manipulation of at least one credit through an at least one account action.

28. The method of claim 27 further comprising the step of displaying a graphic overlay on the viewing device enabling the viewer to respond via a remote control.

29. The method of claim 27 further comprising the steps of the set-top software module transmitting data to a local accounting unit.

30. The method of claim 27 further comprising the step of processing data transmitted to a local accounting unit and performing a reply to the interactive application.

31. The method of claim 30 further comprising the step of conveying the reply to the interactive application.

32. The method of claim 27 wherein initiating a call comprises sending a message to a message construct device.

33. The method of claim 27 wherein step of initiating is performed in accordance with a predetermined event.

34. The method of claim 33 wherein predetermined event is an at least viewer event or an at least one interactive application event.

35. The method of claim 27 further comprising the step of retrieving the account identification associated with the viewer.

36. The method of claim 27 further comprising the step of constructing a message to be sent to an at least one marketing program server, the message comprising account identification and an at least one account action.

37. The method of claim 27 further comprising the step of sending the constructed message to an at least one marketing program server via a return channel via a distribution network.

38. The method of claim 37 further comprising the step of verifying whether return channel is open.

39. The method of claim 38 further comprising the step of sending the constructed message to the at least one marketing program server if the return channel is open for accounting process.

40. The method of claim 38 further comprising the step of establishing a return channel if the channel is not open.

41. The method of claim 37 further comprising the steps of awaiting a reply from marketing program server.

42. The method of claim 41 further comprising the step of passing the message received from the marketing program server from the return channel interface to the message interpreter.

43. The method of claim 41 further comprising the step of de-constructing the reply and extracting the data and passing the de-constructed data to an at least one interactive application

44. The method of claim 27 further comprising the step of the interactive application provides information showing the user's account status in response to a user request or a predetermined event.

45. The method of claim 27 further comprising the step of synchronizing account information located within the at least one set-top box with an at least one marketing program server.

46. The method of claim 27 further comprising the step of translating between customer identification in an at least one first marketing program server and identification of a viewer in an at least one second marketing program server.

47. The method of claim 27 further comprising the step of manipulating account information stored on the at least one set-top box via the at least one interactive application.

48. The method of claim 27 further comprising the step of communicating account information stored on the at least one set-top box or on an at least one marketing program server to an at least one wireless or an at least one computing device.
